(19) United States
(12) Patent Application Publication
(10) Pub. No.: US 2006/0167565 A1
(43) Pub. Date: Jul. 27, 2006

(54) Systems and methods for robust switching using multi-state switch contacts and a common electrical reference

(76) Inventors: Kerfegar K. Katrak, Fenton, MI (US); Paul A. Bauerle, Fenton, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/043,220

(22) Filed: Jan. 26, 2005

(51) Int. Cl. G05B 11/01

(52) U.S. Cl. 700/12

(57) ABSTRACT

Systems, methods and devices are described for robustly determining a desired operating state of a controlled device in response to the position of a multi-position actuator. Two or more switch contacts provide input signals representative of the position of the actuator that are selected between a reference signal and an intermediate signal. Control logic then determines the desired state for the controlled device based upon the input signals received. The desired operating state is determined from any number of operating states defined by the input values.

### TECHNICAL FIELD

The present invention generally relates to multi-state switching logic, and more particularly relates to robust methods, systems and devices for processing multi-state data.

### BACKGROUND

Modern vehicles contain numerous electronic and electrical switches. Vehicle features such as climate controls, audio system controls other electrical systems and the like are now activated, deactivated and adjusted in response to electrical signals generated by various switches in response to driver/passenger inputs, sensor readings and the like. These electrical control signals are typically relayed from the switch to the controlled devices via copper wires or other electrical conductors. Presently, many control applications use a single wire to indicate two discrete states (e.g. ON/OFF, TRUE/FALSE, HIGH/LOW, etc.) using a high or low voltage transmitted on the wire.

To implement more than two states, additional control signals are typically used. In a conventional two/four wheel drive transfer control, for example, four active states of the control (e.g. 2WD mode, auto 4WD mode, 4WD LO mode and 4WD HI mode) as well as a default mode are represented using three to five discrete two-state switches coupled to a single or dual-axis control lever. As the lever is actuated, the various switches identify the position of the lever to place the vehicle in the desired mode. Power take-off (PTO) controls also typically contain three or more discrete switches to represent the various states of the PTO device, which is commonly used to power upfitter-installed accessories such as bucket lifts, snow plows, lift dump bodies and the like. Numerous other multi-state switches use multiple discrete switches to represent the various positions of a single or dual-axis control mechanism, which in turn represent the various states of a controlled device.

While many types of multi-state switches and switching systems have been applied in automotive and other settings, it is presently desirable to formulate multi-state switching devices that reduce the cost, complexity and weight associated with multiple input switches, wires and other components without sacrificing safety or robustness. Moreover, it is often desirable to diagnose certain signal conditions to identify shorts or other electrical issues within the switching system. Furthermore, other desirable features and characteristics will become apparent from the subsequent detailed description and the appended claims, taken in conjunction with the accompanying drawings and the foregoing technical field and background.

### BRIEF SUMMARY

Systems, methods and devices are described for robustly determining a desired operating state of a controlled device in response to the position of a multi-position actuator. In an exemplary embodiment, a robust control system for placing a controlled device into a desired one of a plurality of operating states in response to a position of a multi-position actuator suitably includes two or more sets of switch contacts each coupled to a reference signal and configured to switchably select between the reference signal and an intermediate value. Each set of switch contacts thereby provides an input values selected between the reference signal and the intermediate value in response to the position of the actuator. Control logic appropriately receives the input values and determines the desired operating state for the controlled device based at least in part upon the input values received. Robustness may be provided through proper selection of unique combinations of the input values used to represent the various operating states of the controlled device, as well as through mechanical interlocking and/or other techniques. Various control and switching systems may be formed from any number of contacts, including various configurations capable of representing two, four, eight or other numbers of operating states with one, two, three or more signal inputs.

### BRIEF DESCRIPTION OF THE DRAWINGS

The present invention will hereinafter be described in conjunction with the following drawing figures, wherein like numerals denote like elements, and:

FIG. 1 is a block diagram of an exemplary vehicle;

FIG. 2 is a circuit diagram of an exemplary embodiment of a switching circuit;

FIG. 3 is a circuit diagram of an alternate exemplary embodiment of a switching circuit;

FIG. 4 is a diagram of an exemplary switching system for processing input signals from multiple sets of switching contacts;

FIG. 5 is a diagram of an exemplary robust switching system for processing input signals from multiple sets of interlocked switching contacts having a single electrical reference;

FIG. 6 is a diagram of an exemplary robust switching system for processing input signals from three sets of interlocked switching contacts having a single electrical reference;

FIG. 7 is a diagram of an alternate exemplary robust switching system for processing input signals from three sets of interlocked switching contacts having a single electrical reference; and

FIG. 8 is a diagram of an exemplary four-position selector implemented with robust switching techniques.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

According to various exemplary embodiments, switching controls for use in vehicles and elsewhere may be formulated using ternary switching techniques. In contrast to conventional ternary switching, however, a single or common electrical reference may be used to limit the number of active signal values. Rather than providing the conventional three ternary signal values, for example, various embodiments are configured to provide only two of the three possible states. Because the switching circuitry is capable of detecting three signal values, yet only two values are actually used, the third value can be used as a diagnosable error value. That is, occurrences of the third value can be immediately identified as erroneous. Further, by selecting certain signal input combinations to represent the operating states of the controlled device and/or through mechanical interlocking of multiple switch contacts, the robustness of the system can be preserved, or even improved, over conventional binary signaling implementations. Switching systems as described herein may be used to implement robust selection schemes for various types of control mechanisms, including those used for Normal/Performance/Economy mode switching, cruise control switching, power take off (PTO) controls, “tap up/tap down” switching and/or the like.

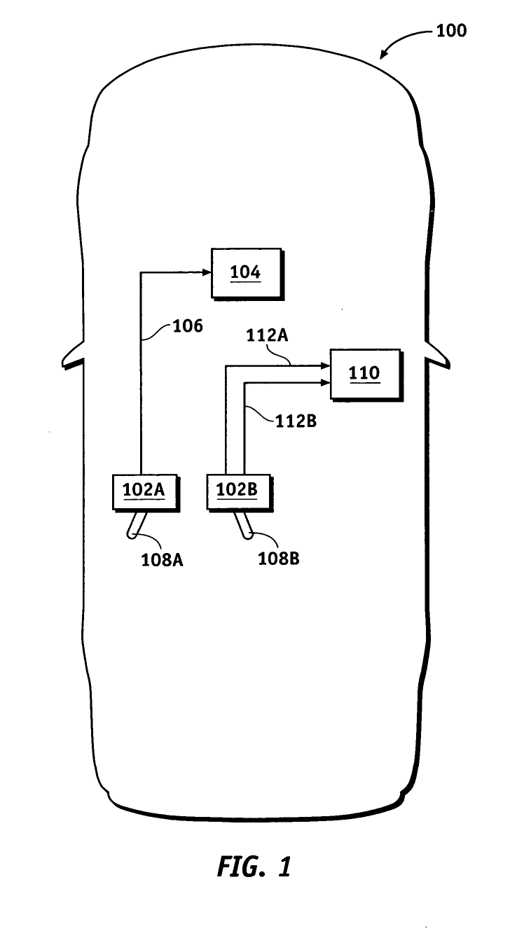

Turning now to the drawing figures and with initial reference to FIG. 1, an exemplary vehicle 100 suitably includes any number of components 104, 110 communicating with various switches 102A, 102B to receive control signals 106, 112A-B, respectively. The various components 104, 110 may represent any electric or electronic devices present within vehicle 100, including, without limitation, 2WD/4WD transfer case controls, cruise controls, power take off selection/actuation devices, multi-position selectors, digital controllers coupled to such devices and/or any other electrical systems, components or devices within vehicle 100.

Switches 102A-B are any devices capable of providing various logic signals 106, 112A-B to components 104, 110 in response to user commands, sensor readings or other input stimuli. In an exemplary embodiment, switches 102A-B respond to displacement or activation of a lever 108A-B or other actuator as appropriate. Various switches 102A-B may be formulated with electrical, electronic and/or mechanical actuators to produce appropriate ternary output signals onto one or more wires or other electrical conductors joining switches 102 and components 104, 110, as described more fully below. These ternary signals may be processed by components 104, 110 to place the components into desired states as appropriate. In various embodiments, a single ternary signal 106 may be provided (e.g. between switch 102A and component 104 in FIG. 1), and/or multiple signals 112A-B may be provided (e.g. between switch 102B and component 110 in FIG. 1), with logic in component 104 (or an associated controller) combining or otherwise processing the various signals 112A-B to extract meaningful instructions. In still further embodiments, binary, ternary and/or other signals may be combined in any suitable manner to create any number of switchable states.

Many types of actuator or stick-based control devices provide several output signals 112A-B that can be processed to determine the state of a single actuator 108B. Lever 108B may correspond to the actuator in a 2WD/4WD selector, electronic mirror control, power take off selector or any other device operating within one or more degrees of freedom. In alternate embodiments, lever 108A-B moves in a ball-and-socket or other arrangement that allows multiple directions of movement. The concepts described herein may be readily adapted to operate with any type of mechanical selector, including any type of lever, stick, or other actuator that moves with respect to the vehicle via any slidable, rotatable or other coupling (e.g. hinge, slider, ball-and-socket, universal joint, etc.).

Referring now to FIG. 2, an exemplary switching circuit 200 suitably includes switch contacts 212, a voltage divider circuit 216 and an analog-to-digital (A/D) converter 202. Switch contacts 212 suitably produce a three-state output signal that is appropriately transmitted across conductor 106 and decoded at voltage divider circuit 216 and/or A/D converter 202.

Switch contacts 212 are any devices, circuits or components capable of producing a binary, ternary or other appropriate output on conductor 106. In various embodiments, switch contacts 212 are implemented with a conventional double-throw switch as may be commonly found in many vehicles. Alternatively, contacts 212 are implemented with a multi-position operator or other voltage selector as appropriate. Contacts 212 may be implemented with a conventional low-current switch, for example, as are commonly found on many vehicles. Various of these switches optionally include a spring member (not shown) or other mechanism to bias an actuator 106 (FIG. 1) into a default position, although bias mechanisms are not found in all embodiments. Switch contacts 212 conceptually correspond to the various switches 102A-B shown in FIG. 1.

Switch contacts 212 generally provide an output signal selected from one or more reference voltages V_{ref} and an “intermediate” or other value not directly associated with a reference signal. In an exemplary embodiment, V_{ref} may be a high or low reference voltage such as ground, a battery voltage or the like. In various embodiments, the reference voltage is the same reference voltage provided to digital circuitry in vehicle 100 (FIG. 1), and may correspond to the reference voltage 214 provided to A/D converter 202. In such embodiments, V_{ref} is on the order of five volts or so, although other embodiments may use widely varying reference voltages. Alternatively, the reference voltage may correspond to an electrical ground, or any other value. The intermediate value provided by contacts 212 may correspond to an open circuit (e.g. not connected to the reference voltage), or may reflect any other intermediate value as appropriate. An intermediate open circuit may be desirable for many applications, since an open circuit will not typically draw a parasitic current on signal line 106 when the switch is in the intermediate state, as described more fully below. Additionally, the open circuit state is relatively easily implemented using conventional low-current three-position switch contacts 212.

Contacts 212 are therefore operable to provide a signal 106 selected from a reference signal (e.g. V_{ref} in the example of FIG. 2) and an intermediate state. This signal 106 is provided to decoder circuitry in one or more vehicle components (e.g. components 104, 110 in FIG. 1) as appropriate. In various embodiments, switch contact 212 is simply a multi-position device that merely selects between the reference voltage (e.g. power or ground) and an open circuit position or other intermediate condition. The contact is not required to provide any voltage division, and consequently does not require electrical resistors, capacitors or other signal processing components other than simple selection apparatus. In various further embodiments, switch 212 optionally includes a mechanical interlocking capability such that only one state (e.g. power, ground, intermediate) can be selected at any given time.

The signals 106 produced by contacts 212 are received at a voltage divider circuit 216 or the like at component 104, 110 (FIG. 1). As shown in FIG. 2, an exemplary voltage divider circuit 216 suitably includes a first resistor 206 and a second resistor 208 coupled to the same high and low reference signals provided to contacts 212, respectively. These resistors 206, 208 are joined at a common node 218, which also receives the ternary signal 106 from switch 212 as appropriate. In the exemplary embodiment shown in FIG. 2, resistor 206 is shown connected to a reference voltage (V_{ref}) 214 while resistor 208 is connected to ground. While the values of resistors 206, 208 vary from embodiment to embodiment, the values may be selected to be approximately equal to each other such that the common node is pulled to a voltage of approximately half the V_{ref} voltage when an open circuit is created by contact 212. Hence, two distinct voltage signals (i.e. V_{ref}/2, V_{ref}) may be provided at common node 218 in response to the value of signal 106. Alternatively, the magnitude of the intermediate voltage may be adjusted by selecting the respective values of resistors 206, 208 accordingly. In various embodiments, resistors 206, 208 are both selected as having a resistance on the order of about 1-50 kOhms, for example about 10 kOhms, although any other values could be used in a wide array of alternate embodiments. Relatively high resistance values may assist in conserving power and heat by reducing the amount of current flowing from V_{ref} to ground, although alternate embodiments may use different values for resistors 206, 208.

The voltages present at common node 208 are then provided to an analog-to-digital converter 202 to decode and process the signals 204 as appropriate. In various embodiments, A/D converter 202 is associated with a processor, controller, decoder, remote input/output box or the like. Alternatively, A/D converter 202 may be a comparator circuit, pipelined A/D circuit or other conversion circuit capable of providing digital representations 214 of the analog signals 204 received. In an exemplary embodiment, A/D converter 202 recognizes the high and low reference voltages, and assumes intermediate values relate to the intermediate state. In embodiments wherein B⁺ is equal to about five volts, for example, A/D converter may recognize voltages below about one volt as a “low” voltage, voltages above about four volts as a “high” voltage, and voltages between one and four volts as intermediate voltages. The particular tolerances and values processed by A/D converter 202 may vary in other embodiments.

As described above, then, signals 106 may be produced by contacts 212, transmitted across a single carrier, and decoded by A/D converter 202 in conjunction with voltage divider circuit 216. Intermediate signals that do not correspond to the traditional “high” or “low” outputs of contact 212 are scaled by voltage divider circuit 216 to produce a known intermediate voltage that can be sensed and processed by A/D converter 202 as appropriate. In this manner, conventional switch contacts 212 and electrical conduits may be used to transmit binary or ternary signals, thereby increasing the amount of information that can be transported over a single conductor. This concept may be exploited across a wide range of automotive and other applications.

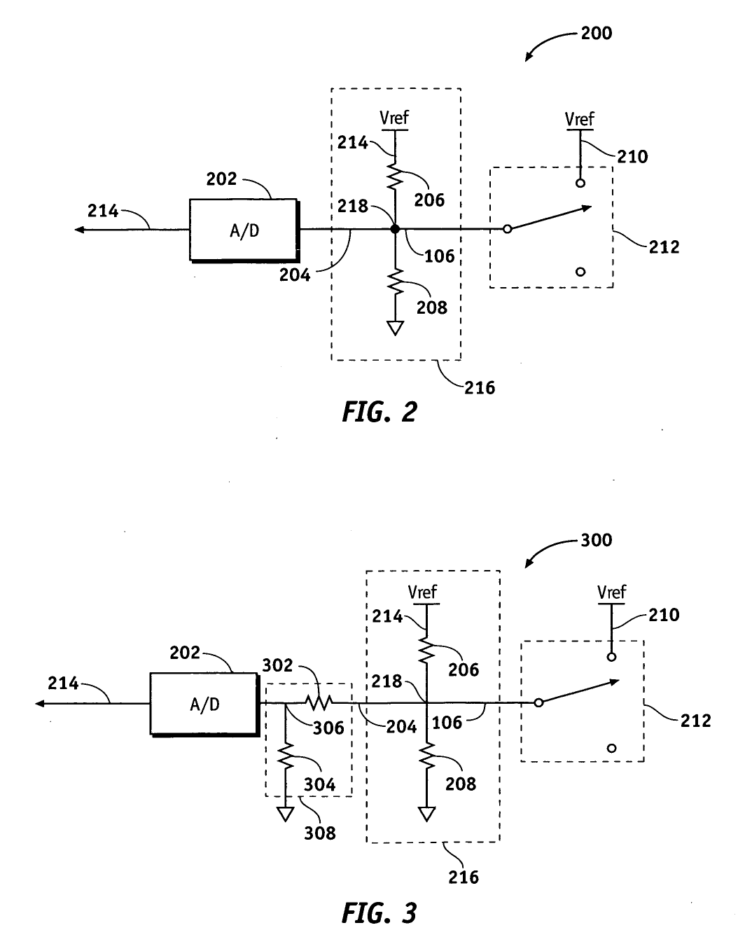

Referring now to FIG. 3, an alternate embodiment of a switching circuit 300 suitably includes an additional voltage divider 308 in addition to contact 212, divider circuit 216 and A/D converter 202 described above in conjunction with FIG. 2. The circuit shown in FIG. 3 may provide additional benefit when one or more reference voltages (e.g. V_{ref}) provided to A/D converter 202 are unavailable or inconvenient to provide to contact 212. In this case, another convenient reference voltage (e.g. a vehicle battery voltage B⁺, a run/crank signal, or the like) may be provided to contact 212 and/or voltage divider circuit 216 as shown. Using the concepts described above, this arrangement provides three distinct voltages (e.g. ground, V_{ref}/2 and V_{ref}) at common node 218. These voltages may be out-of-scale with those expected by conventional A/D circuitry 202, however, as exemplary vehicle battery voltages may be on the order of twelve volts or so. Accordingly, the voltages present at common node 218 are scaled with a second voltage divider 308 to provide input signals 306 that are within the range of sensitivity for A/D converter 202.

In an exemplary embodiment, voltage divider 308 includes two or more resistors 302 and 304 electrically arranged between common node 208 and the input 306 to A/D converter 202. In FIG. 3, resistor 302 is shown between nodes 208 and 306, with resistor 304 shown between node 306 and ground. Various alternate divider circuits 308 could be formulated, however, using simple application of Ohm's law. Similarly, the values of resistors 302 and 304 may be designed to any value based upon the desired scaling of voltages between nodes 218 and 306, although designing the two resistors to be approximately equal in value may provide improved signal-to-noise ratio for circuit 300.

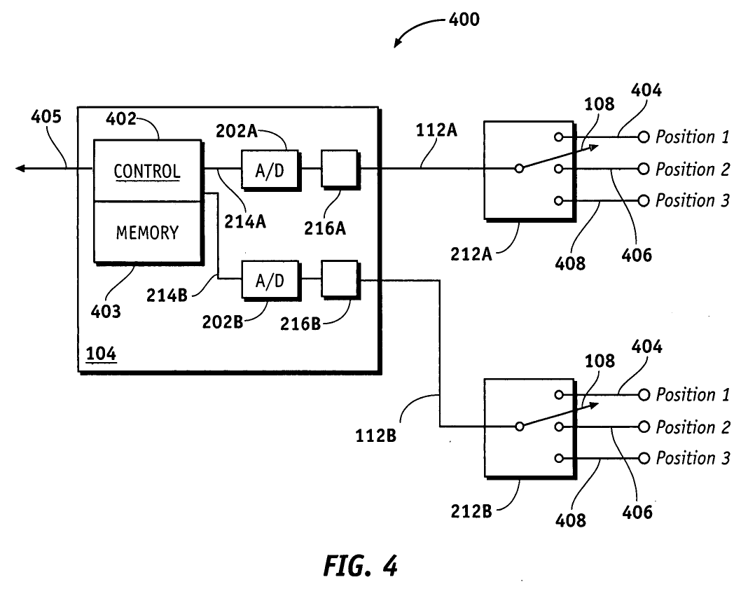

Using the concepts set forth above, a wide range of control circuits and control applications may be formulated, particularly within automotive and other vehicular settings. As mentioned above, the binary and/or ternary signals 106 produced by contacts 212 may be used to provide control data to any number of vehicle components 104, 110 (FIG. 1). FIG. 4 is an exemplary embodiment that makes use of ternary switching techniques is shown. As will be seen below, the general concepts of ternary switching set forth with reference to FIG. 4 could also be exploited in a binary embodiment by simply removing either of the reference voltages (e.g., ground, V_{ref} described above).

With reference now to FIG. 4, the various positions 404, 406, 408 of contacts 212A-B may be appropriately mapped to various states, conditions or inputs 405 provided to component 104. As described above, component 104 suitably includes (or at least communicates with) a processor or other controller 402 that includes or communicates with A/D converter 202 and voltage divider circuit 210 to receive ternary signals 112A-B from contacts 212. The digital signals 214 produced by A/D converter 202 are processed by controller 402 as appropriate to respond to the three-state input received at contacts 212. Accordingly, mapping between states 404, 406 and 408 is typically processed by controller 402, although alternate embodiments may include signal processing in additional or alternate portions of system 400. Signals 214 received from contacts 212 may be processed in any appropriate manner, and in a further embodiment may be stored in a digital memory 403 as appropriate. Although shown as separate components in FIG. 4, memory 403 and processor 402 may be logically and/or physically integrated in any manner. Alternatively, memory 403 and processor 402 may simply communicate via a bus or other communications link as appropriate.

Although FIG. 4 shows an exemplary embodiment wherein controller 402 communicates with two sets of switch contacts 212A-B, alternate embodiments may use any number or arrangement of switch contacts 212, as described more fully below. The various outputs 214A-B of the switching circuits may be combined or otherwise processed by controller 402, by separate processing logic, or in any other manner, to arrive at suitable commands provided to device 104. The commands resulting from this processing may be used to place device 104 into a desired state, for example, or to otherwise adjust the performance or status of the device. In various embodiments, a desired state of device 104 is determined by comparing the various input signals 214A-B received from contacts 212A-B (respectively). The state of device 104, then, can be determined by the collective states of the various input signals 214A-B.

Each exemplary switch contact 212A-B in FIG. 4 is shown as having three possible positions 404, 406 and 408, with each position producing a corresponding value of signals 112A-B. In ternary switching schemes, the three values of signals 112A-B may be referenced as “low”, “high” or “intermediate”, as appropriate. As used herein, the “high” or “1” signal value arbitrarily corresponds to a connection to V_{ref}, B⁺ or another relatively high reference voltage. Similarly, the ‘0’ or ‘low’ signal value suitably corresponds to a short circuit to ground or another appropriate low reference voltage. The ‘Intermediate’ input value is alternately described herein as ‘value’ or ‘v’, and may correspond to an open circuit or other condition of switch 212 that differs from a direct connection to a reference voltage. Although these designations are applied herein for consistency and ease of understanding, the ternary states may be equivalently described using other identifiers such as “0”, “1” and “2”, “A”, “B” and “C”, or in any other convenient manner. The naming and signal conventions used herein may therefore be modified in any manner across a wide array of equivalent embodiments.

In many embodiments, intermediate state 406 is most desirable for use as a “power off”, “default” or “no change” state of device 104, since the open circuit causes little or no current to flow from contacts 212, thereby conserving electrical power. Moreover, an ‘open circuit’ fault is typically more likely to occur than a faulty short to either reference voltage; the most likely fault (e.g. open circuit) conditions may therefore be used to represent the least disruptive states of device 104 to preserve robustness. Short circuit conditions, for example, may be used to represent an “OFF” state of device 104. In such systems, false shorts would result in turning device 104 off rather than improperly leaving device 104 in an “ON” state. On the other hand, some safety-related features (e.g. headlights) may be configured to remain active in the event of a fault, if appropriate. Accordingly, the various states of contacts 212 described herein may be re-assigned in any manner to represent the various inputs and/or operating states of component 104 as appropriate.

Various exemplary mappings of contacts 212 for certain automotive and other applications may be defined as appropriate. The concepts described above may be readily implemented to create a multi-state control that could be used, for example, to control a power takeoff, powertrain component, climate or audio system component, cruise control, other mechanical and/or electrical component, and/or any other automotive or other device. In such embodiments, two or more switch contacts 212 are generally arranged proximate to an actuator 108, with the outputs of the switches corresponding to the various states/positions of actuator 108. Alternatively, however, the various switch contacts 212 could interact with separate actuators 108, with the various input states representing the various positions of the distinct actuators. Stated another way, a common controller 402 may be used to decode the various states of multiple independent switch contacts 212A-B in any manner. Further, any number of binary, ternary and/or other types of switch contacts 212 may be interconnected or otherwise inter-mixed to create switching arrangements of any type.

The mappings and arrangements of input signals used to represent the states of device 104 may be assigned in any manner. In various embodiments, the outputs of the switches may be processed using conventional software logic, logic gates (e.g. AND/NAND, OR/NOR or the like) and/or processing circuitry to determine the state of the actuator. Signals 214A-B may be decoded by software instructions residing within memory 403 and executed by controller 402, for example. Alternatively, decoding logic may be formulated using any discrete, integrated or other components, or with any other combination of hardware and/or software.

In various embodiments, certain combinations of input signals may provide additional benefits such as reduced electrical current consumption, improved safety, or the like. Accordingly, by choosing the particular combinations of input signals used to represent the various operating states of device 104, control system 400 can be designed for improved performance, robustness and/or other factors. By associating the “default” state for device 104 with one or more “open circuit” positions of contacts 212, for example, the amount of current consumed when the device is in the default position may be reduced, since little or no current flows through the contact 212 when the contact is in the intermediate “open circuit” state. Because very little current flows while the switch is in this state, current consumption is minimized in the default state of device 104. Further, using the assumption that open circuits are more likely to be encountered than shorts to ground, which in turn are more likely than shorts to the battery voltage (B⁺), for example, the various device states can be mapped to the inputs such that least-desired state is associated with the input conditions that are least likely to occur accidentally.

Additional benefits may be realized by configuring the switch contacts 212 with a single electrical reference (V_{ref}) such that the output is selected from the reference voltage and the intermediate value (e.g. open circuit). This single reference may correspond to a battery voltage, electrical ground or any other high or low reference value. Such embodiments allow occurrences of the unused signal value to be readily diagnosed at controller 402, thereby quickly identifying fault states or other undesirable conditions. That is, a switching system 400 that uses only “high” and “intermediate” values to represent operating modes of a controlled device can readily diagnose undesired occurrences of shorts to ground (which may appear as “low” values of signals 112A-B). Conversely, switching systems 400 that use only “low” and “intermediate” values can quickly diagnose undesired shorts to the battery voltage. Moreover, a single, common reference voltage may reduce the complexity of switching contacts 212 and/or system 400 as appropriate, and as described more fully below.

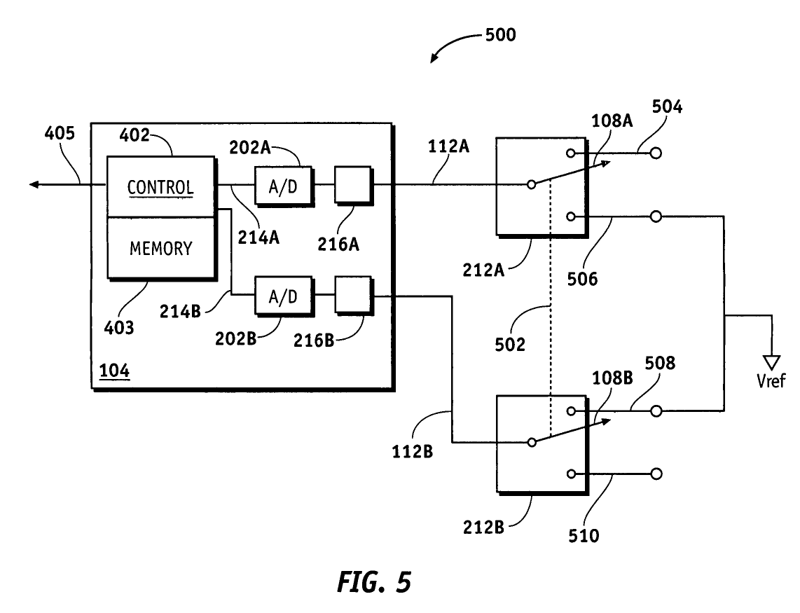

With particular reference now to FIG. 5, an exemplary control system 500 with enhanced robustness and a single reference voltage suitably includes two or more switch contacts 212A-B with actuators 108A-B that are mechanically interlocked such that movement of one actuator 108 results in movement of the other. Stated another way, movement of actuator 108 simultaneously produces electrical activity at both sets of contacts 212A and 212B. FIG. 5 shows mechanical interlocking of two distinct actuators 108A-B though an interconnecting member 502. Alternatively, contacts 212A and 212B may be arranged proximate to a single actuator 108 to provide interlocking, or other physical arrangements could be formulated. FIG. 5 also shows contacts 212A-B configured such that contacts 212B produce a “value/open circuit” signal 112B when contacts 212A produce a “reference” signal (e.g. ground, B⁺, or any other reference voltage) 112A, and vice versa. This phenomenon may be produced through any mechanical, electrical or other physical configuration of contacts 212A-B, and may vary widely from embodiment to embodiment.

The various positions of actuator 108 are therefore indicated by the values of signals 112A and 112B. In the example shown in FIG. 5, for example, a first operating state (“State1”) is represented by actuator 108 being in contact with the open terminal 504 of contact 212A and the reference terminal 508 of contact 212B. A second operating state (“State2”) is represented by actuator 108 being in contact with the reference terminal 506 of contact 212A and the open terminal 510 of contact 212B. The reference terminals 506, 508 may be coupled to any reference voltage or other signals such as ground, a battery voltage (“B+”) or any other electrical reference distinguishable from an open circuit. Other signal configurations could be used in a wide array of alternate but equivalent embodiments.

Because the embodiment shown in FIG. 5 uses a single reference voltage to provide the two active states of system 500, any occurrence of other values can be used to quickly identify a fault condition. If the reference voltage is ground, for example, any occurrences of a battery voltage (B+) identified in signals 214A-B can be readily identified as erroneous. Conversely, erroneous ground signals can be identified when the reference voltage corresponds to the battery voltage or another appropriate value.

Robustness is further enhanced through the use of memory 403 or a similar structure to maintain past values of signals 214A-B for comparison with more contemporaneous values. By comparing prior values of signals 214A-B against current values, any illogical results can be readily identified and flagged or otherwise processed as appropriate. If the system 500 moves from a condition wherein Input1 is the reference voltage and Input2 is an open circuit, for example, to a condition wherein both inputs are open, it can be readily determined that a fault has occurred along Input1 (e.g. a signal line has broken, the reference voltage is no longer available, or the like). Such faults can therefore be isolated, flagged and/or processed as appropriate.

Timing restrictions may also be considered in various switching systems 500. Signal read/sample times, for example, should be configured to be longer than any debounce times associated with the switch contacts 212A-B to prevent erroneous readings. Moreover, in embodiments wherein security parameters are specified, it may be desirable to fix sample frequencies to allow one or more signal reads within the security window. In an exemplary embodiment wherein a 150 milli-second security parameter is specified and the switch contacts have a 10 milli-second debounce time, for example, signals may be read approximately every 20-50 milli-seconds or so to allow for two or more samples to be taken within the security time window. Sampling frequencies may be set within controller 402, or elsewhere as appropriate. Timing requirements may vary significantly from embodiment to embodiment, and may be variously on the order of microseconds or less to the order of seconds or greater. Other embodiments will not contain such stringent time constraints, however, and may not require timing configuration at all.

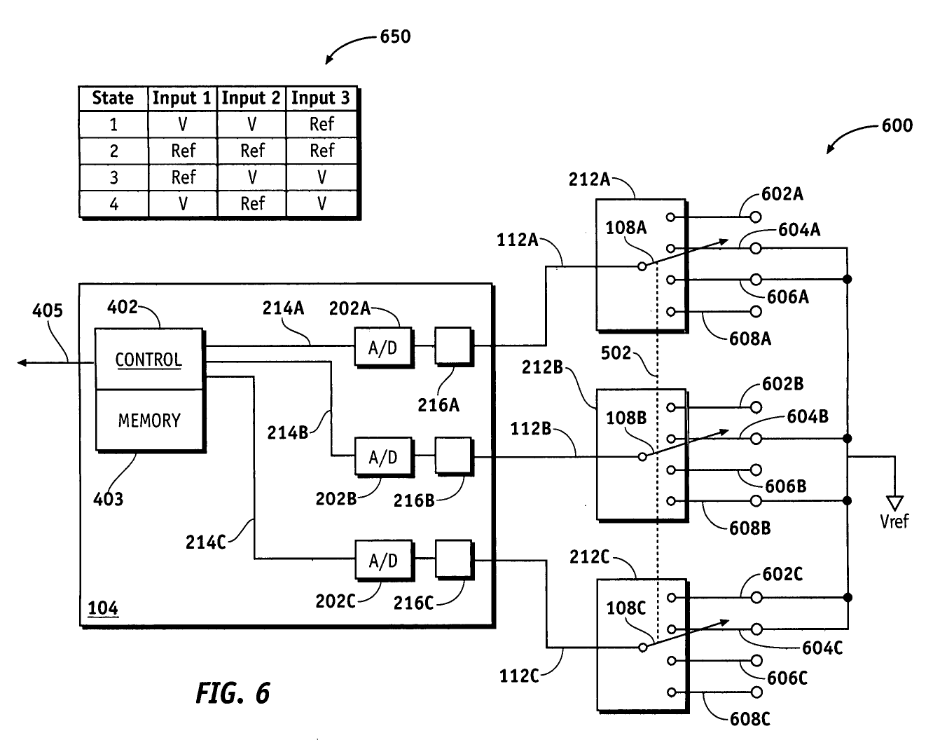

Similar concepts may be applied to embodiments having more than two operating states. FIG. 6 shows an exemplary four-state embodiment 600 implemented with three sets of switching contacts coupled to a single electrical reference (V_{ref}). With reference now to FIG. 6, each of the four operating positions of actuator 108 are represented by four positions 602, 604, 606, 608 of three sets 212A-C of switching contacts as appropriate. Actuator 108 may be implemented with a single actuator, or with two or more mechanically-interconnected actuators 108A-C as shown. The electrical contacts 602, 604, 606, 608 corresponding to the various positions of actuator 108 are appropriately coupled to the reference voltage to provide appropriate signals 214A-C to controller 402. As described above, the reference voltage may be any electrical signal such as ground, battery or the like that is distinguishable from an open circuit. Signals 214A-C produced by contacts 212A-C may be decoded or otherwise processed to indicate the current position of actuator 108 with respect to the various contacts 212A-C. Moreover, signals 214A-C may be compared with prior signal values stored in memory 403 or elsewhere to identify and isolate various fault conditions as appropriate.

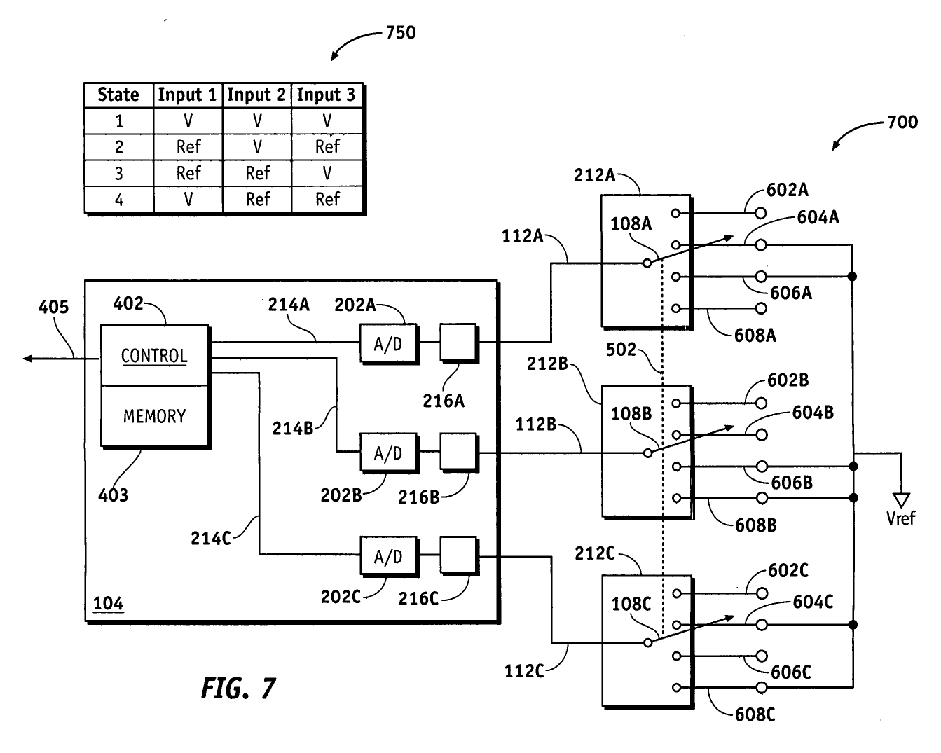

In the exemplary embodiment shown in FIG. 6, positions 604A and 606A of contact 212A, positions 604B and 608B of contact 212B, and positions 602C and 604C of contact 212C are coupled to the reference voltage to implement state table 650. As shown in state table 650, four states of system 600 are represented with various combinations of intermediate (e.g. “value” or open circuit) and reference values of the three signal inputs 214A-C. The various actuator positions 602, 604, 606 and 608 may be coupled to the reference voltage in many other ways to implement a variety of signaling schemes. An alternate embodiment 700 configured to implement the state allocation scheme shown in state table 750, for example, is shown in FIG. 7. In system 700, positions 604A and 606A of contact 212A, positions 606B and 608B of contact 212B, and positions 604C and 608C of contact 212C are coupled to the reference voltage to implement state table 750. State table 650 in FIG. 6 and state table 750 in FIG. 7 represent logical opposites of each other; that is, the signal arrangements shown in table 650 represent fault states for the FIG. 7 signal configuration, and the signal arrangements shown in table 750 represent fault states for the FIG. 6 signal configuration.

Similar concepts may be readily applied to switching systems using four or more inputs as well. In an exemplary four-input system, for example, up to eight unique states may be represented according to the following table:

TABLE 1

| State | Input1 | Input2 | Input3 | Input4 |
|---|---|---|---|---|
| 1 | Ref | v | v | Ref |
| 2 | Ref | Ref | Ref | Ref |
| 3 | Ref | Ref | v | v |
| 4 | Ref | v | Ref | v |
| 5 | v | Ref | Ref | v |
| 6 | v | Ref | v | Ref |
| 7 | v | v | Ref | Ref |
| 8 | v | v | v | v |

As described above, the “Ref” value may refer to any high or low reference voltage, and the “v” may refer to any intermediate, open circuit or other value of the input signal. Accordingly, State 8 in Table 1 may be well-suited for use as a “default” mode in many embodiments to reduce current consumption. Table 1 can be a particularly beneficial embodiment when the “Ref” voltage is designed to be an electrical ground. Table 2 below represents a logical opposite of Table 1 above, with states in Table 2 representing fault states of the operating modes shown Table 1, and vice versa.

TABLE 2

| State | Input1 | Input2 | Input3 | Input4 |
|---|---|---|---|---|
| 1 | Ref | Ref | Ref | v |
| 2 | Ref | Ref | v | Ref |
| 3 | Ref | v | Ref | Ref |
| 4 | v | Ref | Ref | Ref |
| 5 | v | v | v | Ref |
| 6 | Ref | v | v | v |
| 7 | v | v | Ref | v |
| 8 | v | Ref | v | v |

Many other arrangements of switches and signals could be formulated, with any signal or switch combinations used to represent any actuator position and/or operating mode of a controlled device in a wide array of alternate but equivalent embodiments.

The exemplary switching systems described with reference to FIGS. 5-7 and Tables 1-2 exhibit several marked advantages over prior art switches implemented with discrete components. By using the “open circuit”/intermediate signal to represent various operating states, current and power consumption in the system is appropriately reduced. Moreover, only a single electrical reference (e.g. ground or B⁺) needs to be provided to the switching contacts to provide robust signaling. Still further, because the systems are capable of decoding ternary signaling, the number of fault modes that can be quickly and readily detected is appropriately increased.

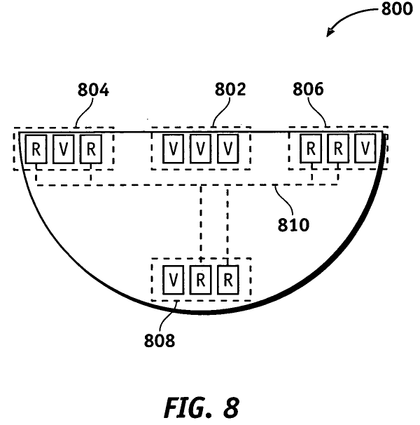

The concepts set forth herein may be applied in any number of practical settings, including various settings in automotive and other environments. By mapping the various operating positions of actuator 108 to the operating modes of a controlled device, numerous embodiments could be formulated across a wide array of commercial and other settings. FIG. 8, for example, shows an exemplary four-position control 800 based upon three input signals 214A-C (FIG. 7). Although the signals and positions of control 800 could be configured in any manner, the embodiment shown in FIG. 8 includes a default position 802 and three mode select positions 804, 806 and 808 represented by states one through four of state table 750 (FIG. 7). Default position 802 may be assigned to the “state1” mapping of table 750, since this state is represented by three open circuits, and therefore represents a relatively low power consumption when control 800 is in the default position. Positions 804, 806 and 808 are arbitrarily assigned to states 2, 3 and 4 in FIG. 8, although other embodiments may incorporate any other signal mappings and state assignments. The various reference (“R”) contacts across the various states may be interconnected in any manner, as indicated by dashed line 810.

Control 800 could be used to implement any type of actuator-driven input device. Each of the various actuator positions 802, 804, 806 and 808 of control 800 could correspond to any “economy”, “performance” and/or “normal” operating modes of an engine or other vehicle component, for example. In such embodiments, the normal operating mode could correspond to “Default” position 802 to reduce the amount of current flow during normal operation. Similarly, the other non-default positions 804, 806 and 808 could be readily associated with other operating states of the controlled device. Alternate embodiments could use similar arrangement to implement audio or climate controls, for example, as well as engine controls or other vehicle controls. Similar concepts could be applied in audio or climate control systems, cruise control systems, power takeoff systems, engine throttle controls, transmission controls and/or any other control systems in automotive or other environments. Again, the concepts described herein could be applied across a wide array of equivalent applications.

The general concepts described herein could be modified in many different ways to implement a diverse array of equivalent multi-state switches, actuators and other controls. The various positions of actuator 108 may be extracted and decoded through any type of processing logic, including any combination of discrete components, integrated circuitry and/or software, for example. Moreover, the various positional and switching structures shown in the figures and tables contained herein may be modified and/or supplemented in any manner. Still further, the concepts presented herein may be applied to any number of ternary and/or discrete switches, or any combination of ternary and discrete switches to create any number of potential or actual robust and non-robust state representations. Similar concepts to those described above could be applied to four or more input signals, for example, allowing for control systems capable of processing any number of robust states in a wide array of equivalent embodiments.

Although the various embodiments are most frequently described with respect to automotive applications, the invention is not so limited. Indeed, the concepts, circuits and structures described herein could be readily applied in any commercial, home, industrial, consumer electronics or other setting. Ternary switches and concepts could be used to implement a conventional joystick, for example, or any other pointing/directing device based upon four or more directions. The concepts described herein could similarly be readily applied in aeronautical, aerospace, marine or other vehicular settings as well as in the automotive context.

While at least one exemplary embodiment has been presented in the foregoing detailed description, a vast number of variations exist. The various circuits described herein may be modified through conventional electrical and electronic principles, for example, or may be logically altered in any number of equivalent embodiments without departing from the concepts described herein. The exemplary embodiments described herein are intended only as examples, and are not intended to limit the scope, applicability, or configuration of the invention in any way. Rather, the foregoing detailed description will provide those skilled in the art with a convenient road map for implementing one or more exemplary embodiments. Various changes can therefore be made in the functions and arrangements of elements set forth herein without departing from the scope of the invention as set forth in the appended claims and the legal equivalents thereof.

What is claimed is:

1. A robust control system for placing a controlled device into a desired one of a plurality of operating states in response to a position of a multi-position actuator, the system comprising:
a first set of switch contacts coupled to a reference signal and configured to switchably select between the reference signal and an intermediate value to provide a first input value in response to the position of the actuator;
a second set of switch contacts coupled to the reference signal and configured to switchably select between the reference signal and the intermediate value to provide a second input value in response to the position of the actuator; and
control logic configured to receive the first and second input values and to determine the desired operating state for the controlled device based at least in part upon the first and second input values received, wherein each of the plurality of operating states is represented by a unique combination of the first and second input values.

2. The control system of claim 1 wherein the intermediate value corresponds to an open circuit.

3. The control system of claim 2 wherein one of the plurality of operating states is represented by the first input value having the reference value and the second input signal having the intermediate value.

4. The control system of claim 3 wherein a second one of the plurality of operating states is represented by the first input value having the intermediate value and the second input signal having the reference value.

5. The control system of claim 1 further comprising a third set of switch contacts coupled to the reference signal and configured to switchably select between the reference signal and the intermediate value to provide a third input value in response to the position of the actuator, and wherein the control logic is further configured receive the third input value and to determine the desired operating state for the controlled device based upon the first, second and third input values.

6. The control system of claim 5 wherein one of the plurality of operating states corresponds to a default operating state.

7. The control system of claim 6 wherein the default operating state is represented by each of the first, second and third input signals having the intermediate value.

8. The control system of claim 5 wherein the plurality of operating states are represented by the first, second and third input signals as:

| State | Input1 | Input2 | Input3 |
|---|---|---|---|
| 1 | v | v | Ref |
| 2 | Ref | Ref | Ref |
| 3 | Ref | v | v |
| 4 | v | Ref | v |

wherein “Ref” represents the reference value and “v” represents the intermediate value.

9. The control system of claim 5 wherein the plurality of oerating states are represented by the first, second and third input signals as:

| State | Input1 | Input2 | Input3 |
|---|---|---|---|
| 1 | v | v | v |
| 2 | Ref | v | Ref |
| 3 | Ref | Ref | v |
| 4 | v | Ref | Ref |

wherein “Ref” represents the reference value and “v” represents the intermediate value.

10. The control system of claim 9 wherein State1 corresponds to a default state.

11. The control system of claim 1 wherein the control logic comprises fault determination logic configured to identify fault conditions from the first and second input signals.

12. The control system of claim 11 further comprising a memory in communication with the fault determination logic.

13. The control system of claim 1 wherein the reference signal is an electrical ground.

14. The control system of claim 1 wherein the first and second value inputs are selected from three distinct ternary values, said three distinct ternary values comprising the reference signal, the intermediate value, and a third value.

15. The control system of claim 14 wherein the control logic is further configured to identify a fault condition upon the occurrence of the third value.

16. A method of determining a desired one of a plurality of operating states of a controlled device from a position of a multi-position actuator, the method comprising the steps of:
receiving a first input signal having a reference value or an intermediate value indicative of the position of the multi-position actuator with respect to a first switch contact;
receiving a second input signal having the reference value or the intermediate value indicative of the position of the multi-position actuator with respect to a second switch contact; and
processing the first and second input signals to determine the desired operating state of the controlled device.

17. The method of claim 16 wherein the intermediate state corresponds to an open circuit.

18. The method of claim 16 wherein one of the plurality of operating states is represented by the first input value having the reference value and the second input signal having the intermediate value.

19. The method of claim 18 wherein a second one of the plurality of operating states is represented by the first input value having the intermediate value and the second input signal having the reference value.

20. The method of claim 16 further comprising the step of receiving a third input value having the reference value or the intermediate value indicative of the position of the multi-position actuator with respect to a third switch contact, and wherein the processing step further comprises processing the third input value to determine the desired operating state for the controlled device based upon the first, second and third input values.

21. The method of claim 16 wherein one of the plurality of operating states corresponds to a default operating state.

22. The method of claim 21 wherein the default operating state is represented by each of the first, second and third input signals having the intermediate value.

23. The method of claim 20 wherein the plurality of operating states are represented by the first, second and third input signals as:

| State | Input1 | Input2 | Input3 |
|---|---|---|---|
| 1 | v | v | Ref |
| 2 | Ref | Ref | Ref |
| 3 | Ref | v | v |
| 4 | v | Ref | v |

wherein “Ref” represents the reference value and “v” represents the intermediate value.

24. The method of claim 20 wherein the plurality of operating states are represented by the first, second and third input signals as:

| State | Input1 | Input2 | Input3 |
|---|---|---|---|
| 1 | v | v | v |
| 2 | Ref | v | Ref |
| 3 | Ref | Ref | v |
| 4 | v | Ref | Ref |

wherein “Ref” represents the reference value and “v” represents the intermediate value.

25. The method of claim 24 wherein State1 corresponds to a default state.

26. The method of claim 26 further comprising the step of identifying fault conditions from the first and second input signals.

27. The method of claim 26 wherein the identifying step comprises obtaining prior values for the first and second input signals from a memory.

28. The method of claim 16 wherein the intermediate value and the reference value are selected from three distinct ternary values.

29. The method of claim 28 wherein the processing step comprises identifying a fault condition upon the occurrence of the third distinct ternary value.

30. An apparatus for determining a desired one of a plurality of operating states of a controlled device from a position of a multi-position actuator, the device comprising:
means for receiving a first and a second input signal, wherein each of the first and second input signals exhibit either a reference value or an intermediate value indicative of the position of the multi-position actuator; and
means for processing the first and second input signals to determine the desired operating state of the controlled device as a function of the first and second input signals.
